(19) United States
(12) Patent Application Publication
(10) Pub. No.: US 2009/0018675 A1
(43) Pub. Date: Jan. 15, 2009

(54) Process Control System and Method for Operating a Process Control System

(76) Inventor: Sahid Abu-Bakarr Sesay, Western Australia (AU)

Correspondence Address: PAUL, HASTINGS, JANOFSKY & WALKER LLP, 875 15th Street, NW, Washington, DC, 20005, US

(21) Appl. No.: 11/816,988

(22) PCT Filed: Feb. 23, 2006
(86) PCT No.: PCT/AU06/00230

§ 371 Date: Aug. 22, 2008

(30) Foreign Application Priority Data
Feb. 23, 2005 (AU) 2005900822

(51) Int. Cl. G05B 19/048

(52) U.S. Cl. 700/17; 700/19

(57) ABSTRACT

A process control system comprising: a programmable automation controller (“PAC”) (12); and at least one process control peripheral device (14). The peripheral devices are controlled by the PAC depending upon user-configured settings. The PAC uses an operating system which comprises a kernel, a configuration process and run-time processes. The run-time processes comprises a number of sub-processes that allow the PAC to monitor and log the peripheral devices and/or environment and control the peripheral devices in accordance with the configurations and any changes to the environment in which the peripheral devices are located.

### FIELD OF THE INVENTION

The present invention relates to a process control system and method for operating a process control system. In particular, the process control system and method for operating a process control system is adapted to be controlled by an end user without the need of the specialist expertise of a process control engineer or similarly capable person.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

### BACKGROUND ART

The following discussion of the background of the invention is intended to facilitate an understanding of tie invention: However, it should be appreciated that the discussion is not an acknowledgement or admission that any of the material referred to was published, known or part of the common general knowledge of the person skilled in the art in any jurisdiction as at the priority date of the invention.

The ability to monitor a process to improve the process is vital to the operation of much commerce. As an example, intensive farming ventures (where vegetable, fish, fowl or beast, is grown in a limited space with tightly controlled inputs) have typically deployed automation usually through the use of programmable logic controllers (“PLCs”). While this approach is functional there are many reasons that this is not of advantage.

The primary problem is that it is difficult for the end user to set up and later modify the control scheme. Typically, a process control engineer or similarly capable person is required to design a control process. Any improvement thereafter will also require their expertise. This is problematic as, while there may be known optimal control conditions for some situations, in many cases the control scheme will require adjustment or redesign to suit localised conditions.

Aquaculture, for example, covers a wide range of species, each having different growing conditions. As well as this, pond and tank sizes may vary leading to the need to find the optimum control process by trial and continuous improvement methods. If control expertise is needed at each trial stage this will be costly. Furthermore, many ventures are located in rural areas where such expertise is not readily available. This results in inconvenience, increased cost and a considerable time lag in implementing growing cycle improvements. Each venture then finds it difficult to optimise and improve its competitive advantage.

PLC systems have other disadvantages. A PLC needs to be placed relatively close to the phenomena under measurement or control. Proprietary protocols are used to communicate with and to program the PLC typically by, using ladder logic. The process control engineer generally uses a software package to do this. Furthermore, the process control engineer needs to use a second software package to configure the PLCs. Yet another software package is needed to view the operation of the PLCs, be it over the internet or locally.

The requirement for such separate software packages adds complexity and physical cost as well as increasing the time needed to program the system. This also translates into a higher total cost of ownership where, the cost of equipment being equal, the engineering time to program and manage systems is significant.

The present invention seeks to provide a process control system and method for operating a process control system that alleviates at least one of the aforementioned problems to some extent.

### DISCLOSURE OF THE INVENTION

In accordance with a first aspect of the present invention, there is provided a process control system comprising a programmable automation controller and first and second process control peripheral devices coupled thereto, each process control peripheral device being in data and control communication with the programmable automation controller, wherein the programmable automation controller is operable to: monitor a current situation of an environment in which at least one of the first or second process control peripheral devices is located; log a previous situation; and control at least one of the first or second process control peripheral devices depending upon the current and previous situations, the programmable automation controller being further operable to: configure the first and second process control peripheral devices; perform data acquisition on at least one of the first and second process control peripheral devices; and provide controlling operations by writing data to at least one of the first and second process control peripheral devices coupled to the programmable automation controller in response to the data acquisition and in accordance with the configuration of the first and second process control peripheral devices.

Preferably, the programmable automation controller includes an operating system comprising a kernel, a configuration process and a run-time process, each of the configuration and run-time processes comprising a plurality of sub-processes having a specific functionality associated therewith, the configuration process being operable to configure the first and second process control peripheral devices through end user inputs to the programmable automation controller, the end user inputs being stored in memory of the programmable automation controller for use by the run-time process.

Preferably, one of the sub-processes is a Central Process operable to read data from other sub-processes and from the first and second process control peripheral devices, and to output data to those processes needed for control of at least one of the first and second process control peripheral devices.

Preferably, one of the sub-processes is a Backup Process for providing back up of data.

Preferably, one of the sub-processes is a Benchmarking Process for benchmarking data against other similar criteria.

Preferably, one of the sub-processes is a Communications Process for controlling the communication of data to an end user of the process control system.

Preferably, one of the sub-processes is a Data Pusher for pushing data and/or text that needs to be updated to a visual display means coupled to the programmable automation controller.

Preferably, one of the sub-processes is a Designing Process for designing an interface between an end user and the process control system.

Preferably, one of the sub-processes is a Video Capture Process for capturing video and/or audio frames or streams from process control peripheral devices comprising video image capturing devices and/or audio capturing devices.

Preferably, one of the sub-processes is a Video Process for creating streamed video and/or audio from the Video Capture Process.

Preferably, one of the sub-processes is an Image Grabber Process for capturing images from process control peripheral devices comprising still image capturing devices.

Preferably, one of the sub-processes is an Image Pusher Process for pushing images from a process control peripheral device to an image receiving device coupled to the programmable automation controller.

Preferably, one of the sub-processes is a System Install Process operable to facilitate initial installation, and diagnostic processes stored on the programmable automation controller after installation.

Preferably, one of the sub-processes is a Sequence Process operable by an end user to customise the operability of the process control system.

Preferably, one of the sub-processes is a Plot Process for controlling the plotting of data stored on the programmable automation controller.

Preferably, one of the sub-processes is a Scanner Process for scanning the process control peripheral devices coupled to the programmable automation controller to determine the state of at least one of the process control peripheral devices coupled thereto and to determine a value indicative of that state, whereby the programmable automation controller is operable to compare the scanned value with a predetermined stored value and, where a difference between the scanned value and the stored value are determined, the programmable automation controller is operable to display an indication of the difference on a display means coupled to the programmable automation controller.

Preferably, one of the sub-processes is a Scheduler Process for scheduling actions and operations of the process control system.

Preferably, one of the sub-processes is a System Update Process for updating the process control system.

Preferably, one of the sub-processes is a Utilities Process operable to determine the optimal operation and current status of the process control system.

Preferably, one of the sub-processes is a Writer Process operable to write output data to process control peripheral devices, and memory.

Preferably, the first and second process control peripheral devices are separate devices. Alternatively, the first and second process control peripheral devices are the same device.

In accordance with a second aspect of the present invention, there is provided a programmable automation controller for use with the process control system of the first aspect of the present invention, wherein the programmable automation controller is operable to: monitor a current situation of the environment in which the at least one of the first or second process control peripheral devices is located; log a previous situation; and control at least one of the first or second process control peripheral devices depending upon the current and previous situations, the programmable automation controller being further operable to: configure the first and second process control peripheral devices; perform data acquisition on at least one of the first and second process control peripheral devices; and provide controlling operations by writing data to at least one of the first and second process control peripheral devices coupled to the programmable automation controller in response to the data acquisition and in accordance with the configuration of the first and second process control peripheral devices.

Preferably, the programmable automation controller includes an operating system comprising a kernel, a configuration process and a run-time process, each of the configuration and run-time processes comprising a plurality of sub-processes having a specific functionality associated therewith, the configuration process being operable to configure the first and second process control peripheral devices through end user inputs to the programmable automation controller, these end user inputs being stored in memory of the programmable automation controller for use by the run-time process.

Preferably, one of the sub-processes is a Central Process operable to read data from other sub-processes and from the first and second process control peripheral devices and to output data to those processes needed for control of at least one of the first and second process control peripheral devices.

Preferably, one of the sub-processes is a Backup Process for providing back up of data.

Preferably, one of the sub-processes is a Benchmarking Process for benchmarking data against similar criteria.

Preferably, one of the sub-processes is a Communications Process for controlling the communication of data to an end user of the process control system.

Preferably, one of the sub-processes is a Data Pusher for pushing data and/or text that needs to be updated to a visual display means coupled to the programmable automation controller.

Preferably, one of the sub-processes is a Designing Process for designing an interface between an end user and the process control system.

Preferably, one of the sub-processes is a Video Capture Process for capturing video and/or audio frames or streams from process control peripheral devices comprising video image capturing devices and/or audio capturing devices.

Preferably, one of the sub-processes is a Video Process for creating streamed video and/or audio from the Video Capture Process.

Preferably, one of the sub-processes is an Image Grabber Process for capturing images from process control peripheral devices comprising still image capturing devices.

Preferably, one of the sub-processes is an Image Pusher Process for pushing images from a process control peripheral device to an image receiving device coupled to the programmable automation controller.

Preferably, one of the sub-processes is a System install Process operable to facilitate initial installation, and diagnostic processes stored on the programmable automation controller after installation.

Preferably, one of the sub-processes is a Sequence Process operable by an end user to customise the operability of the process control system.

Preferably, one of the sub-processes is a Plot Process for controlling the plotting of data stored on the programmable automation controller.

Preferably, one of the sub-processes is a Scanner Process for scanning the process control peripheral devices coupled to the programmable automation controller to determine the state of at least one of the process control peripheral devices coupled thereto and to determine a value indicative of that state, whereby the programmable automation controller is operable to compare the scanned value with a predetermined stored value and, where a difference between the scanned value and the stored value are determined, the programmable automation controller is operable to display an indication of the difference on a display means coupled to the programmable automation controller.

Preferably, of the sub-processes is a Scheduler Process for scheduling actions and operations of the process control system.

Preferably, one of the sub-processes is a System Update Process for updating the process control system.

Preferably, one of the sub-processes is a Utilities Process operable to determine the optimal operation and current status of the process control system.

Preferably, one of the sub-processes is a Writer Process operable to write output data to process control peripheral devices, and memory.

Preferably, the first arid second process control peripheral devices are separate devices. Alternatively, the first and second process control peripheral devices, are the same, device.

In accordance with a third aspect of the present invention, there is provided a method for operating a process control system, the process control system, comprising a programmable automation controller and first and second process control peripheral devices coupled thereto, each process control peripheral device being in data and control communication with the programmable automation controller, the method including the steps of: monitoring a current situation of an environment in which at least one of the first or second process control peripheral devices is located; logging a previous situation; and controlling at least one of the first or second process control peripheral devices depending upon the current and previous situations, the method including the further steps of: configuring the first and second process control peripheral devices; performing data acquisition on at least one of the first and second process control peripheral devices; and providing controlling operations by writing data to at least one of the first and second process control peripheral devices coupled to the programmable automation controller in response to the data acquisition and in accordance with the configuration of the first and second process control peripheral devices.

Preferably, the configuration, data acquisition and controlling are provided by a configuration process and a run-time process, each of the configuration and run-time processes comprising a plurality of sub-processes having a specific functionality associated therewith, the configuration process being operable to configure the first and second process control peripheral devices through end user inputs to the programmable automation controller, these end user inputs being stored in memory of the programmable automation controller for use by the run-time process.

Preferably, one of the sub-processes is a Central Process operable to read data from other sub-processes and from the first and second process control peripheral devices, and to output data to those processes needed for control of at least one of the process control peripheral devices.

Preferably, one of the sub-processes is a Backup Process for providing back up of data.

Preferably, one of the sub-processes is a Benchmarking Process for benchmarking data against other similar criteria.

Preferably, one of the sub-processes is a Communications Process for controlling the communication of data to an end user of the process control system.

Preferably, one of the sub-processes is a Data Pusher for pushing data and/or text that needs to be updated to a visual display means coupled to the programmable automation controller.

Preferably, one of the sub-processes is a Designing Process for designing an interface between an end user and the process control system.

Preferably, one of the sub-processes is a Video Capture Process for capturing video and/or audio frames or streams from process control peripheral devices comprising video image capturing devices and/or audio capturing devices.

Preferably, one of the sub-processes is a Video Process for creating streamed video and/or audio from the Video Capture Process.

Preferably, one of the sub-processes is an Image Grabber Process for capturing, images from process control peripheral devices comprising still image capturing devices.

Preferably, one of the sub-processes is a Image Pusher Process for pushing images from a process control peripheral device to an image receiving device coupled to the programmable automation controller.

Preferably, one of the sub-processes is a System Install Process operable to facilitate initial installation, and diagnostic processes stored on the programmable automation controller after installation.

Preferably, one of the sub-processes is a Sequence Process operable by an end user to customise the operability of the process control system.

Preferably, one of the sub-processes is a Plot Process for controlling the plotting of data stored on the programmable automation controller.

Preferably, one of the sub-processes is a Scanner Process for scanning the process control peripheral devices coupled to the programmable automation controller to determine the state of at least one of the process control peripheral devices coupled thereto and to determine a value indicative of that state, whereby the scanned value is compared with a predetermined stored value and, where a difference between the scanned value and the stored value are determined, the method including the further step of displaying an indication of the difference on a display means coupled to the programmable automation controller.

Preferably, one of the sub-processes is a Scheduler Process for scheduling actions and operations of the process control system.

Preferably, one of the sub-processes is a System Update Process for updating the process control system.

Preferably, one of the sub-processes is a Utilities Process operable to determine the optimal operation and current status of the process control system.

Preferably, one of the sub-processes is a Writer Process operable to write output data to process control peripheral devices, and memory.

Preferably, the first and second process control peripheral devices are separate devices. Alternatively, the first and second process control peripheral devices are the same device.

In accordance with a fourth aspect of the present invention, there is provided a process control system comprising a programmable automation controller and at least one process control peripheral device coupled thereto, the at least one process control peripheral device being in data and control communication with the programmable automation controller, wherein the programmable automation controller is operable to: monitor the current situation of an environment in which the at least one process control peripheral device is located; log a previous situation; and control the at least one process control peripheral device depending upon the current and previous situations, the programmable automation controller being further operable to: configure the at least one process control peripheral device; perform data acquisition on the at least one process control peripheral device; and provide controlling operations by writing data to the at least one process control peripheral device coupled to the programmable automation controller.

In accordance with a fifth aspect of the present invention, there is provided a programmable automation controller for a process control system having at least one process control peripheral device coupled thereto, the at least one process control peripheral device being in data and control communication with the programmable automation controller, wherein the programmable, automation controller is operable to: monitor the current situation of an environment in which the at least one process control peripheral device is located; log a previous situation; arid control the at least one process control peripheral device depending upon the current and previous situations, the programmable automation controller being further operable to: configure the at least one process control peripheral device; perform data acquisition on the at least one process control peripheral device; and provide controlling operations by writing data to the at least one process control peripheral device coupled to the programmable automation controller.

In accordance with a sixth aspect of the present invention, there is provided a method for operating a process control system, the process control system comprising a programmable automation controller and at least one process control peripheral device coupled thereto, the at least one process control peripheral device being in data and control communication with the programmable automation controller, wherein the method comprises the steps of: monitoring the current situation of an environment in which the at least one process control peripheral device is located; logging a previous situation; and controlling the at least one process control peripheral device depending upon the current and previous situations, the method including the further steps of: configuring the at least one process control peripheral device; performing data acquisition on the at least one process control peripheral device; and providing controlling operations by writing data to the at least one process control peripheral device coupled to the programmable automation controller.

By providing a programmable automation controller and a process control system using such a programmable automation controller as described above, a process control system is implemented which allows devices to be added and removed as required, and then configured by the end user, without requiring different software or requiring expert help to do so. In such a way, automation becomes available to smaller operations because it can be configured and used by the end user and has ah attendant smaller cost associated with it.

### BRIEF DESCRIPTION OF THE DRAWINGS

The present invention will now be described, by way of example only, with reference to the accompanying drawings, of which:

FIG. 1 is a schematic representation of the hardware components of a first; embodiment of a process control system in accordance with an aspect of the present invention;

FIG. 2 is a schematic view of the components of the operating system for the process control system of FIG. 1;

FIG. 3 is a schematic view of the interface processes used by the programmable automation controller of the process control system of FIG. 1;

FIG. 4 is a schematic view of the main processes used by the operating system of FIG. 2;

FIG. 5 is a schematic view of the operation/function of the Backup Process used by the operating system of FIG. 2;

FIG. 6 is a schematic view of the operation/function of the Benchmarking Process used by the operating system of FIG. 2;

FIG. 7 is a schematic view of the operation/function of the Communications Process used by the operating system of FIG. 2;

FIG. 8 is a schematic view of the operation/function of the Data Pusher used by the operating system of FIG. 2;

FIG. 9 is a schematic view of the operation/function of the human/machine interface used by the operating system of FIG. 2;

FIG. 10 is a schematic view of the operation/function of the Video Capture Process used by the operating system of FIG. 2;

FIG. 11 is a schematic view of the operation/function of the image Grabber Process used by the operating system of FIG. 2;

FIG. 12 is a schematic view of the operation/function of the image Pusher Process used by the operating system of FIG. 2;

FIG. 13 is a schematic view of the operation/function of the System Install Process used by the operating system of FIG. 2;

FIG. 14 is a schematic view of the operation/function of the Macros/Auto Sequence Process used by the operating system of FIG. 2;

FIG. 15 is a schematic view of the operation/function of the Plot Process used by the operating system of FIG. 2;

FIG. 16 is a schematic view of the operation/function of the Scanner Process used by the operating system of FIG. 2;

FIG. 17 is a schematic view of the operation/function of the Scheduler Process used by the operating system of FIG. 2;

FIG. 18 is a schematic view of the operation/function of the System Update Process used by the operating system of FIG. 2;

FIG. 19 is a schematic view of the operation/function of the Utilities Process used by the operating system of FIG. 2;

FIG. 20 is a schematic view of the operation/function of the Video Process used by the operating system of FIG. 2;

FIG. 21 is a schematic view of the operation/function of the Writer Process used by the operating system of FIG. 2;

FIG. 22 is a screen capture of an environment definition screen of the process control system of FIG. 1 and used in the configuration process;

FIG. 23 is a screen capture of a first device definition screen of the process control system of FIG. 1 showing a digital output form window in full used in the configuration process;.

FIG. 24 is a screen capture of the first device definition screen of FIG. 23 also showing an analogue input form window in full used in the configuration process;

FIG. 25 is a screen capture of the first device definition screen of FIG. 23 also showing an analogue output form window and digital input form window in full used in the configuration process;

FIG. 26 is a screen capture of a trigger setting form window of the process control system of FIG. 1 used in the configuration process;

FIG. 27 is a screen capture of an alarm setting form window of the process control system of FIG. 1 used in the configuration process;

FIG. 28 is a screen capture of a schedule setting form window of the process control system of FIG. 1 used in the configuration process; and

FIG. 29 is a screen capture of a user interface of the process control system of FIG. 1 used in the configuration process.

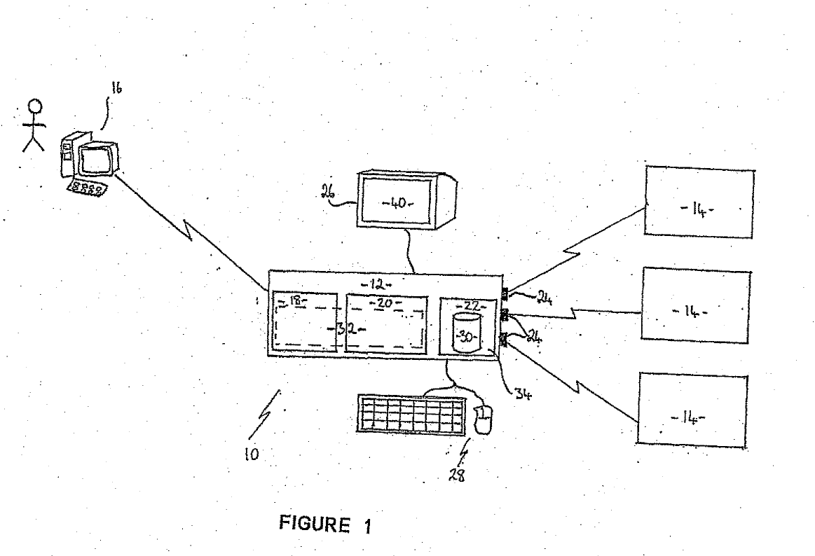

### BEST MODE(S) FOR CARRYING OUT THE INVENTION

In accordance with a first embodiment of the invention there is a process control system 10 comprising:

a programmable automation controller (“PAC”) 12;

at least one process control peripheral device 14; and

optionally, a computer 16 located remotely from the PAC 12.

The PAG 12 comprises memory 18, processor 20, storage means 22 and I/O ports 24. In this embodiment, PAC 12 also includes display means 26, in the form of a monitor, and data input means 28, in the form of a keyboard and mouse.

Storage means 22 includes a database 30. Storage means 22 may take a variety of forms including a fixed or removable hard disc or solid state memory means. Similarly, I/O ports 24 may take a variety of forms including cable, wireless, infrared and PCI/ISA card.

The PAC 12 is in data communication with at least one process control peripheral device 14 and remote computer 16 through I/O ports 24. The remote computer 16 is in control communication with the PAC 12. The PAC 12 is in control communication with at least one process control peripheral device 14. In this example, data and control communication is achieved through non-proprietary communication standards, such as TCP/IP and Bluetooth. In practice there will probably be several process control peripheral devices 14. Some peripheral devices 14 may perform logging/measurement/sensing functions, some may provide control functions and so may provide both.

At least one process control peripheral device 14 may be a sensor, an actuator, a video camera, a still image camera or any other appropriate device. The peripheral device 14 can be one from which data is read, one from which data is output to, or one which has data read to and data output therefrom. The computer 16 is typically of standard configuration as would be evident to the person skilled in the art.

The process control system 10, and, in particular the PAC 12 which provides the operational functionality of the process control system 10, includes' an operating system for control and operation of the PAC 12 and the peripheral devices 14 coupled thereto.

The functionality of the PAC 12 (and the process control system 10 as a whole) can be broken down into three main components: monitoring of a current situation of the environments) in which the peripheral devices 14 are located, and of the peripheral devices 14/process control system 10; logging of the previous situation; and the control of the peripheral devices 14/process control system 10 depending upon the current and previous situations. The process control and automation is achieved through: configuration of the coupled peripheral devices 14 that carry out specific functions such as measuring, monitoring or controlling physical phenomena; environments and devices within those environments; performing data acquisition on peripheral devices 14 attached to the PAC 12; and providing controlling operations by writing data to other peripheral devices 14 coupled to the PAC 12, or to the same peripheral device 14, depending upon the structure, function and operation of the peripheral device 14. This enables the connected peripheral devices 14 to be configured and operated to run any appropriate process control environment, for example to control buildings, security systems or production environments.

A user, who may or may not be a process engineer or other similarly skilled person, installs at least one process control peripheral device 14 at a desired location. The user then installs the PAC 12 at an additional desired location and takes such action as necessary to secure data and control communication between the PAC 12 and at least one process control peripheral device 14. In this example, the user also takes such action as necessary to secure data and control communication between the PAC 12 and computer 16.

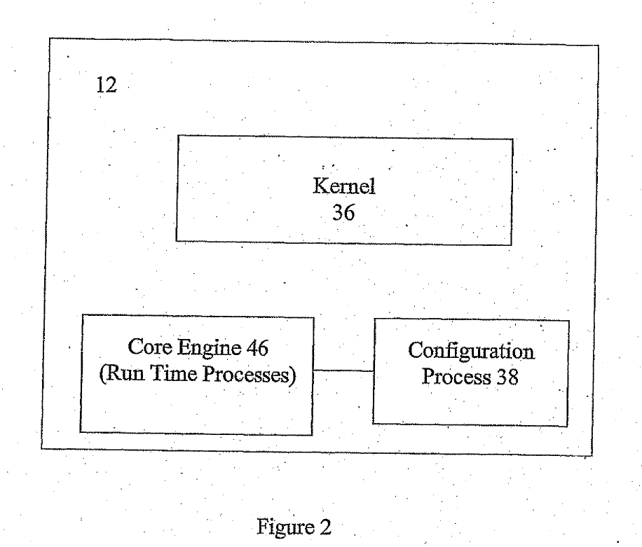

The PAC 12 operates under control of software that serves to allow operation of the process control system 10. This software includes three main components, namely a real time computer kernel 36, a configuration process 38 for configuration of the process control system 10, and run-time processes 42 for functions such as measuring, monitoring, control, and data acquisition. The kernel 36 in the preferred embodiment is one such as Linux or Unix although other suitable kernels could be used. This is illustrated schematically in FIG. 2.

The software can be written using any suitable programming language.

The configuration process 38 and the run-time processes 42 comprise a plurality of functional sub-processes, the functions and operations of which will be described further below. These sub-processes work together to provide the functionality described herein.

It is advantageous for the sub-processes to be implemented separately within the PAC 12. In embodiments of the invention they could be combined so that they are implemented in combination in a single unit or in multiple units so that the end user is seamlessly given access to the functions provided.

The configuration process 38 includes a Human Machine Interface (“HMI”) 40 that captures end user inputs. These details are saved on the process control system 10 for the run-time processes 42 to use. The configuration process 36 is implemented through ah interface process 44, while the run-time processes 42 are implemented in a core engine 46.

In the present embodiment of the invention, the configuration process 38 provides the following, and which are implemented by the end user:

discovery of peripheral devices attached to the system are reported, which are then named and saved;

environments added to the system;

devices added to the system;

devices configured with logging, trigger & alarm values (as required);

camera(s) configured (if any and as required);

times configured to schedule monitoring/controlling of cameras and devices

sequences of events added that control devices when monitored devices have transcended certain values or are in a particular state;

dependent relationships added between devices (as required) which the system uses during the run-time process 42 to perform an action, i.e. control a device or camera;

display current status of each connected camera/device and the overall process control system 10;

updating of camera/device/system configuration during run time;

creation of virtual devices;

simulation of a process control system;

other users added to the process control system 10 with allocated permissions;

system configuration preferences added to the process control system 10; and

contact details added to enable the process control system 10 to send alerts to end user(s) for human intervention

Besides the above summarised configuration process, the interface process 44 also performs the following functionality:

uploading/downloading comma separated file(s) or similar comprising logging, trigger, alarm, configured device/system details/etc;

scheduling of automatic/manual back up of data and/or images to internal or external storage;

entering and retrieving data relating to research/testing/various scenarios/devices/environments;

providing system health information parameters/alerts/display as configurable by the end user;

providing system health information displayed on the display means 26;

displaying date/time for an environment where the process control system 10 resides;

providing for the creation of layout/schematic/icons by the end user;

The interface process 44 could be stored locally on the PAC 12 or it could be browsed over a network. This interface process 44 allows the end user to interact with the operation, actions and data of the process control system 10.

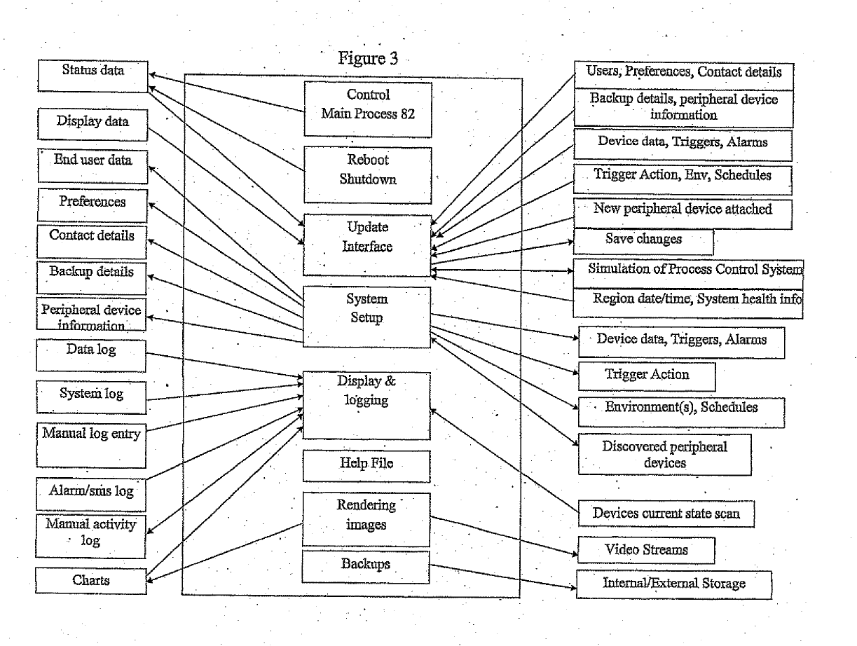

FIG. 3 is a schematic illustration of the functions of the interface process 44. The interface process 44, which—as discussed above—provides for configuration of the process control system 10, and includes a number of sub-processes (indicated in FIG. 3) which allow for an end user to input data, as well as to receive data from, and send data to, peripheral devices 14. Examples of this input data as displayed in FIG. 2 are alarm, trigger and other data from peripheral devices as well as end user inputs such as preferences, and contact details. In particular, an update process 48 receives data from peripheral devices 14 and end user inputs, system set-up data is input via the system setup process 50, which is then operable to set up any coupled peripheral devices 14, store input data and so on. Display and logging processes 52 provide for the logging of data and appropriate display through an image rendering process 54. The interface process 44 can also provide for reboot and shutdown, backup and end user help.

The core engine 46 comprises a number of sub-processes which run the various run-time processes and provide for operation of the process control system 10 in conjunction with the configuration processes described above. These sub-processes are:

Backup Process 60 for backing up data;

Benchmarking Process 62 for benchmarking data against other process control systems;

Communications Process 64 to control output to communications devices such as the Internet, mobile phones and other communications devices;

Data Pusher 66 for pushing data that needs to be updated to the display means 26;

HMI Design 68 for enabling design of the HMI 40;

Video Capture Process 70 for capturing video and/or audio streams for peripheral devices 14 that are video cameras;

Image Grabber Process 72 for capturing images from peripheral, devices that are still cameras;

Image Pusher 74 for pushing images to browser interfaces and/or any image receiving device;

System Install 76 facilitating initial installation and diagnostic processes;

Macros/Auto Sequence Process 78 enabling an end user through the HMI and the interface process 44 to customise automation sequences;

Plot Process 80 for controlling data plotting;

Main Process 82;

Scanner Process 84 for scanning the current status of the coupled peripheral devices 14;

Scheduler Process 86 for scheduling actions and operations;

System Update 88 for updating the process control system 10;

Utilities Process 90 for determining the optimal operation of the process control system 10, and the current status of the process control system 10;

Video Process 92 for creating streamed video and/or audio from the Video Capture Process 70; and

Writer Process 94 for writing output data.

These processes will now be described in more detail.

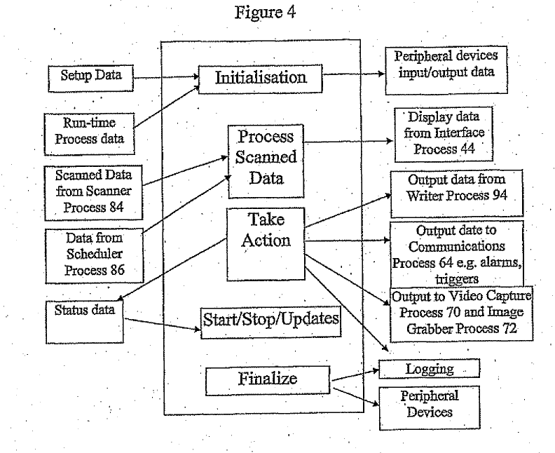

The Main Process 82 is illustrated in FIG. 4. The Main Process 82 is a central process operable to read data from other processes and from peripheral devices 14 and to output data to those processes needed to control the required actions such as controlling peripheral devices, taking measurements, logging data and so on. In particular, it provides the following operations:

performs initialisation for ail processes on start up;

reads information from peripheral devices 14 into memory 18;

reads triggers, alarms & device dependencies information from peripheral devices 14 into memory 18;

reads system information into memory 18;

reads errors information into memory 18;

reads schedule information from the Scheduler Process 86 into memory 18;

reads information from the Communications Process 64 into memory 18

reads start/stop update information, calculates and sets offsets/gradients for analogue inputs and outputs from relevant process control peripheral devices 14, as necessary, and initialises process control peripheral devices 14 as per normal/default state or as configured by the end user. It also writes input data from peripheral devices 14 for the Scanner Process 84;

reads scanned data as generated by the Scanner Process 84, and instructs trigger &/or dependant peripheral device actions as configured by the end user. It also writes output data for the Writer Process 94, writes display data for the Interface Process 44 and writes streaming request for the Image Grabber Process 72;

instructs alarm action;

writes video capture requests for the Video Capture Process 70; and

writes to an error log (scan/connection, output, cameras, device, system) and/or the Communications Process 64.

The Main Process 82 uses schedules information to instruct the Image Grabber Process 72 and the Writer Process 94 as to when to undertake action.

Each of the other processes will now be described.

### Backup Process 60 (FIG. 5)

This process provides for backup of relevant data. In particular, this process:

reads data with user configurable settings from the Scheduler Process 86 (daily/weekly/monthly);

reads data with user configurable settings from the Interface Process 44 (which files/data/etc and storage medium);

reads data with devices information &/or,

reads data with system information &/on

reads camera information data where the peripheral devices 14 are cameras;

backs up data and/or images to internal or external storage—manually or automatically; and

logs actions performed.

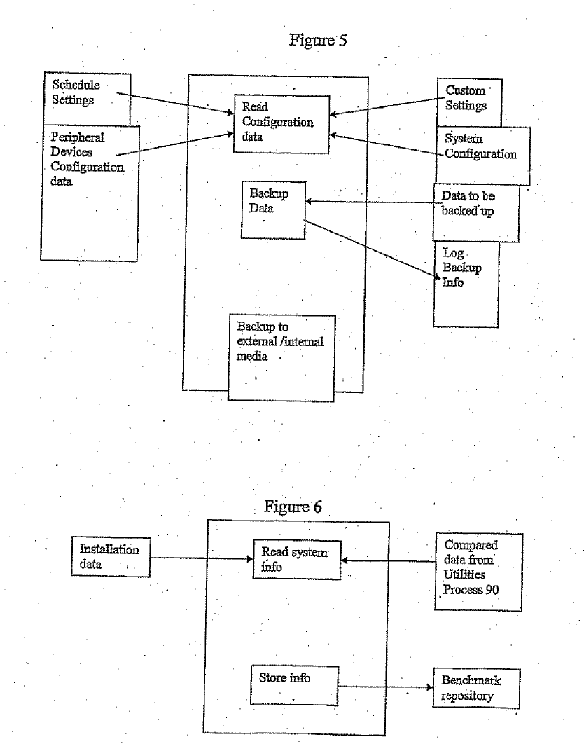

### Benchmarking Process 62 (FIG. 6)

This process enables the operation of the process control system 10 to be benchmarked against other systems, the number of inputs/outputs and other similar criteria. In particular, this process:

reads data from the System Install Process 76;

reads data from the Utilities Process 90; and

stores data for comparison.

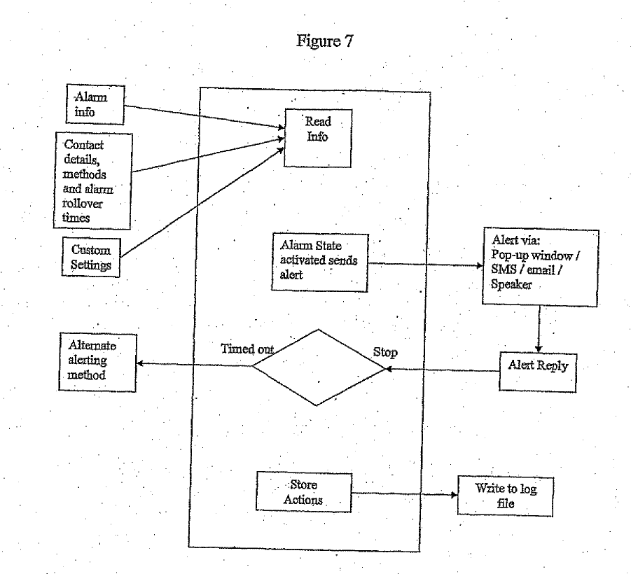

### Communications Process 64 (FIG. 7)

This process deals communication of alarms, alerts and other messages to users of the process control system 10, for example via the internet, mobile phone or other communications devices in particular, this process performs the following functions:

reads data with alarms information for peripheral devices 14 and the process control system 10;

reads data with contact details, method and configured intervals as configured during the configuration process to send alerts;

reads data with user configurable settings from the Scheduler Process 86 (activation times);

sends data at user configured intervals—via an appropriate communications means—when a peripheral device 14 is in an alarm mode and during activation time until a response is received &/or the peripheral device 14/process control system 10 is no longer in alarm mode;

sends next method of alerting if no response is received within configured rollover time;

writes actions performed to a log—for example using email, SMS; and

writes actions performed for the Main Process 82 (e.g. popup window message);

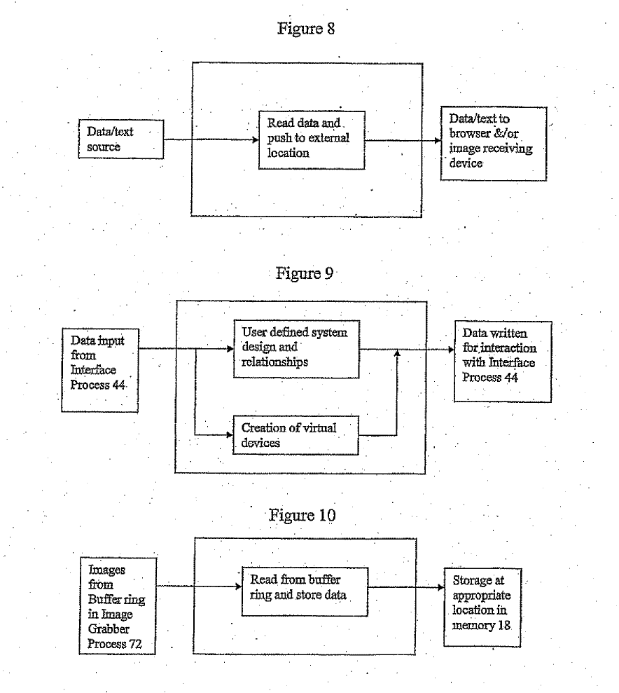

### Data Pusher 66 (FIG. 8)

This process pushes data/text that needs to be updated to the display means 26 such as displayed values/colours, alarms or changes in operating conditions or updating trends and graphs. For example it may indicate the status of a peripheral device 14 or text that shows the status of an environment such as how much water is in a fish tank.

### HMI Design 68 (FIG. 9)

This process enables the end user to design their own automation screens which may:

be on multiple screens/layers;

contain priority information;

permit a browseable hierarchy of environments and devices;

Using the HMI 40, the end user may develop interrelationships beyond simple device/camera/system/priority/environment dependencies (sequencing, timing).

Virtual devices may be created to be used as timers or other functions, and may be incorporated in the Macros/Auto Sequence Process 78.

### Video Capture Process 70 (FIG. 10)

This captures video frames or streams from appropriate peripheral devices 14 such as video cameras or other video image capture devices, gets image frames from a buffer ring used in the Image Grabber Process 72 and stores them in an appropriate location in memory 18, The video streams may also include audio data, captured from appropriate peripheral devices 14 such as microphones.

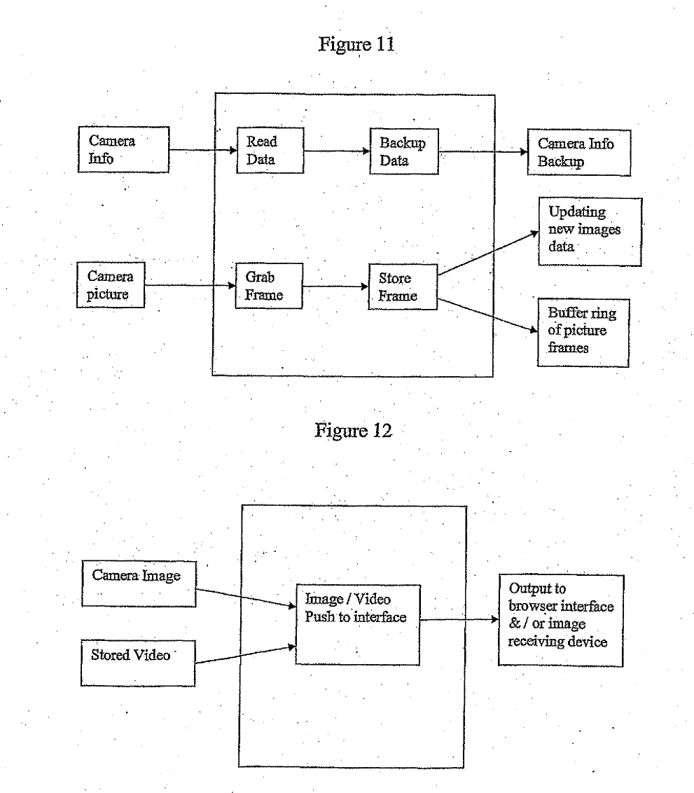

### Image Grabber Process 72 (FIG. 11)

This process:

reads information data from still cameras or other similar still image capture devices;

creates a backup of the data;

deletes the data;

grabs picture frames from peripheral devices 14 attached to the process control system 10; and

stores the grabbed picture frame in two areas: a first area stores new images, and a second area contains a buffer ring of the picture frames.

### Image Pusher 74 (FIG. 12)

This process pushes image frames and video images for peripheral devices 14 to browser interface &/or an image receiving device.

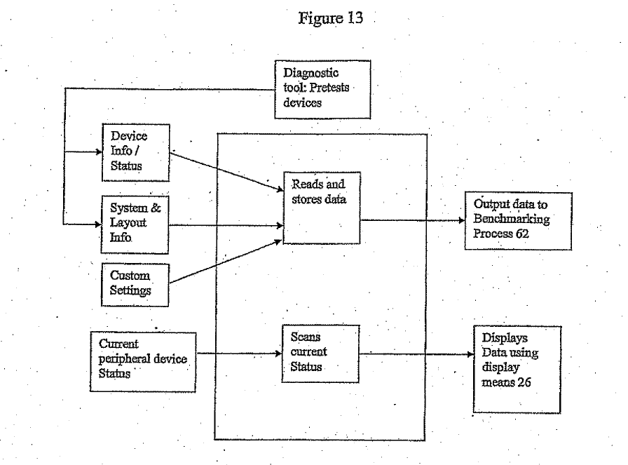

### System Install 76 (FIG. 13)

As well as facilitating initial installation of the process control system 10, this process provides a diagnostic tool to pre-test peripheral devices 14 and for troubleshooting purposes after installation. The process:

reads and stores peripheral device information;

reads and stores process control system & layout information;

reads and stores all logging/trigger/alarm/etc information;

reads and stores current status of connected cameras/devices;

reads and stores all configurable input information as set up using the Configuration Process 38;

reads and stores installer and end user contact details;

reads and stores any changes to the above initial settings;

scans current status of all cameras/devices and displays; and

sends above details to the Benchmarking Process 62.

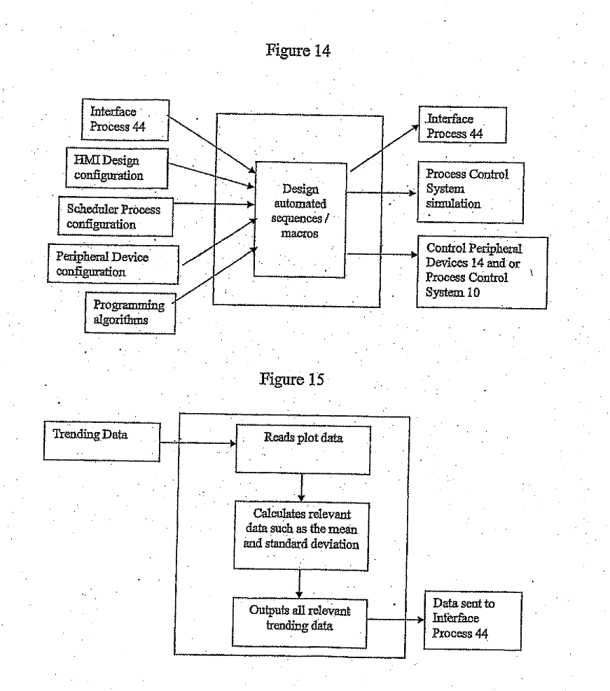

### Macros/Auto Sequence Process 78 (FIG. 14)

As discussed above, the end user can create their own automation sequences under control of the Interface Process 44, and which, may:

be based on the screens developed using the HMI design process 68;

comprise programming algorithms;

be drag and drop &/or selected from drop down lists or similar;

be connected to the Scheduler Process 86;

be connected to other device/system configuration;

be used to simulate the proposed process control system 10 or proposed extensions thereto;

be connected to the Interface Process 44;

each automation sequence may:

comprise multiple steps;

perform logic functionality,

be edited or deleted;

be initiated by event &/or time; and

be grouped by Environment &/or User &/or Program group.

### Plot Process 80 (FIG. 15)

This process reads data such as trending data, and plots mean, standard deviation, date/time, device name and other useful criteria as configured. It couples data to the interface process which displays selected parameters graphically.

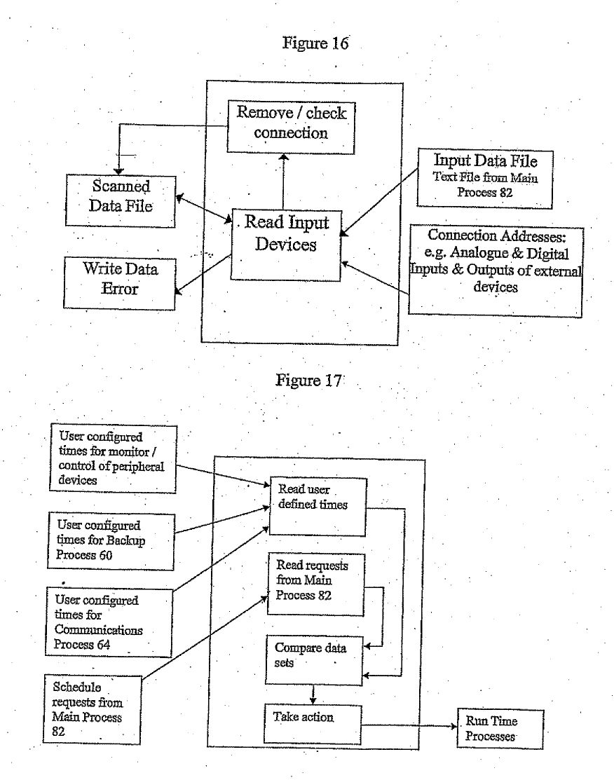

### Scanner Process 84 (FIG. 16)

This process scans attached peripheral devices 14 for data connection and errors. It reads the connection addresses that are needed for data acquisition and stores it into memory 18. It establishes a connection with each peripheral device 14 from input devices data. If there are connection or device errors then it writes data to an error log, and removes the peripheral device 14 from scan list if an error occurs, and then periodically checks connection for removed device/address. In addition, this process scans the current value for each peripheral device 14 from input devices data, writes scan results data, creates a backup of said data, and deletes this data as appropriate.

### Scheduler Process 86 (FIG. 17)

This process reads into memory 18 end user configurable times that are set to monitor/control peripheral devices 14. In addition, the Scheduler Process 86 reads these end user configurable times into memory 18 for back up purposes. It also reads end user configurable times used by the Communications Process 64 into memory 18, it reads scheduling requests from the Main Process 82, it compares with configurable times stored in memory 18, and performs appropriate write actions.

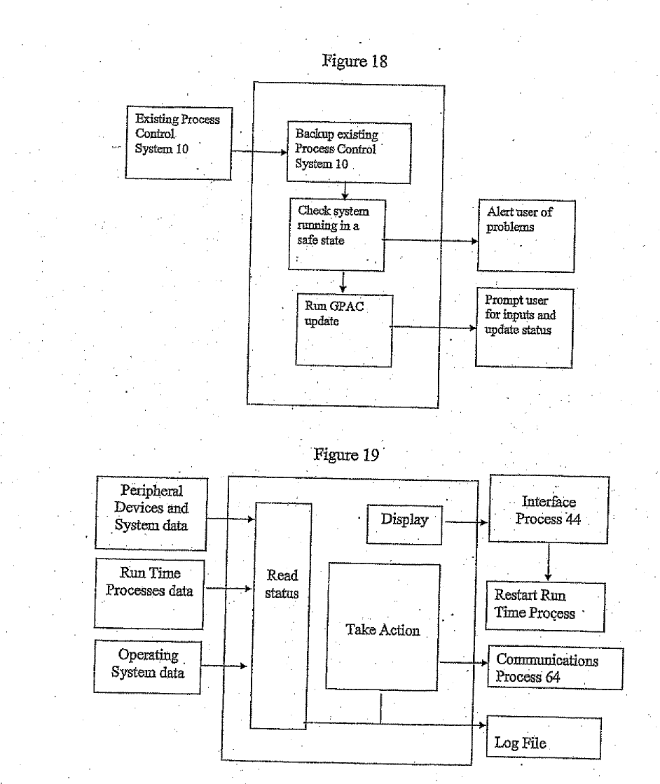

### System Update 88 (FIG. 18)

This process copies the configuration and run-time processes, as well as log and data files. It checks these processes to ensure that the processes are operating in a safe state, and to prompt an end user if not. The System Update Process 88 runs update processes which copy changed files and check connections, peripheral devices 14, and functionality and prompts provided to user for input &/or status of update.

### Utilities Process 90 (FIG. 19)

This process determines whether the run-time processes are running optimally, it displays the current status of all these processes on the display means 26 under control of the interface process 44. Any run-time processes that are not running are automatically restarted and action logged. Alternatively, they may be manually restarted by the end user. Process control system 10 health information is read, and parameters/alerts calculated. Optimisation options are also provided. This process is also used to check resource usage such as hard disk remaining, memory usage, and processor 20 usage. If end user interaction is required, then this process is operable to send an alert through the Communications Process 64.

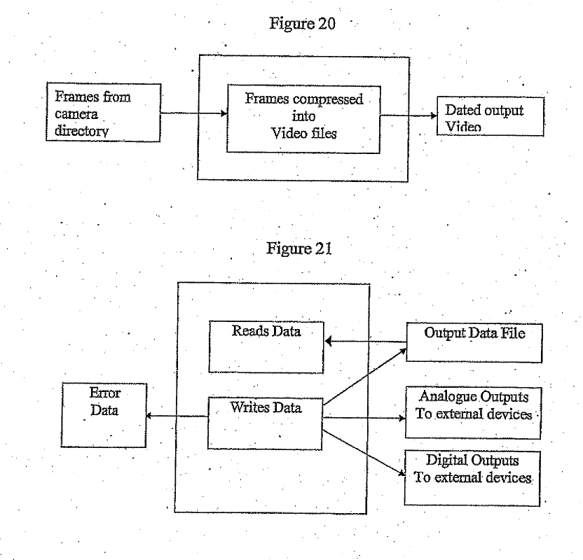

### Video Process 92 (FIG. 20)

As discussed above, this process creates streamed video (and audio if appropriate) from picture frames copied to an appropriate location in memory 18 by Video Capture Process 70 and as configured by the user from the selected peripheral device 14 at the scheduled time.

### Writer Process 94 (FIG. 21)

This process reads data acquisition data from peripheral devices 14 that output data. It creates a backup of this data, and deletes the data as appropriate. This process also writes to peripheral devices 14 as dictated by relevant data output by a peripheral device 14 and reports any errors, and logs data.

An example of the way in which an end user could configure the process control system 10 and the coupled peripheral devices 14 will now be discussed. In this example, the user configures the process control system 10 using; the display means 26 and data input means 28 connected to the PAC 12. It should be appreciated, however, that the configuration process can be initiated and controlled via computer 16 through appropriate modification as would be known to persons skilled in the art.

Configuring the process control system 10 uses the processes stored on the PAC 12 and discussed above. Execution of the software 32 is achieved through appropriate use of processor 20 and memory 18 in a manner well known to persons skilled in the art.

Software 32 commences with a registration process for authenticating the identity of the user. Once, authenticated, the software 32 checks to see whether the process control system 10 has previously been configured by checking for the existence of a peripheral configuration file 34.

If the process control system 10 has not previously been configured, the software 32 scans the I/O ports 24 for any process control peripheral devices 14. Upon detection of a process control peripheral device 14, the software 32 operates to obtain details of the process control peripheral device 14. In this manner, the software 32 operates in a manner similar to the “plug and play” procedure known to persons skilled in the art.

When the scan of all I/O ports 24 is complete, the details obtained in respect of each process control peripheral device 14 are displayed to the user via display means 26. The user is then asked to confirm, using data input means 28, that the details of ail process control peripheral devices 14 displayed on the display means 26 correspond with all process control peripheral devices 14 connected to the PAC 12. Upon confirmation, the software 32 queries the user as to whether they wish to proceed to define environments within the process control system 10.

If the software 32 is unable to detect any process control peripheral device 14, or the user cannot confirm correlation, the user is prompted to check mat the process control peripheral device 14 is properly connected and powered before the software 32 initiates a re-scan. Alternatively, the user may terminate execution of the software 32.

If the user proceeds to define environments, a form window 100, as shown in FIG. 21, or similar, is displayed to the user via display means 26. In the embodiment described herein, form window 100 requires the user to enter in the following data:

The name to be given to the environment. An environment may take its name from the location where some of the process control peripheral device 14 is sited, for example “Tank 001”, or may take the form of an indication of the object upon which some of the process control peripheral devices 14 function, for example “Lights”.

An identifying code;

A description of the size in units; and

A description of the unit used to measure size, i.e. litres, square meters, gallons, etc.

The user is also prompted to select a shape from radio button grouping 102 to be used when displaying the environment. This is explained in more detail below.

The user can view and/or modify the defined environments, as well as add yet further environments, by means of tool bar 106. The icons 108 on toolbar 106 allow the user to add, edit or delete each entry

When the user has defined all the environments applicable to the process to be controlled Software 32 then commits the defined environments as records of the appropriate tables in database 30.

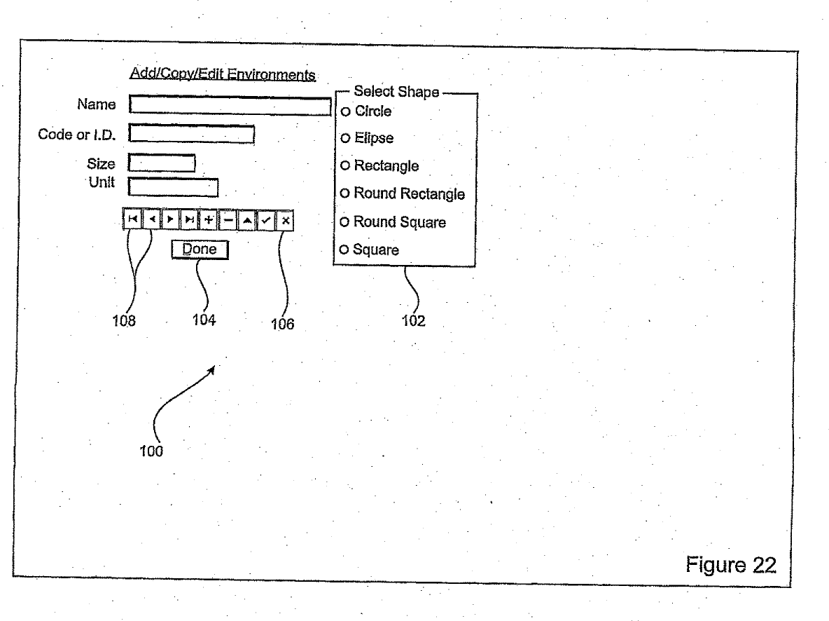

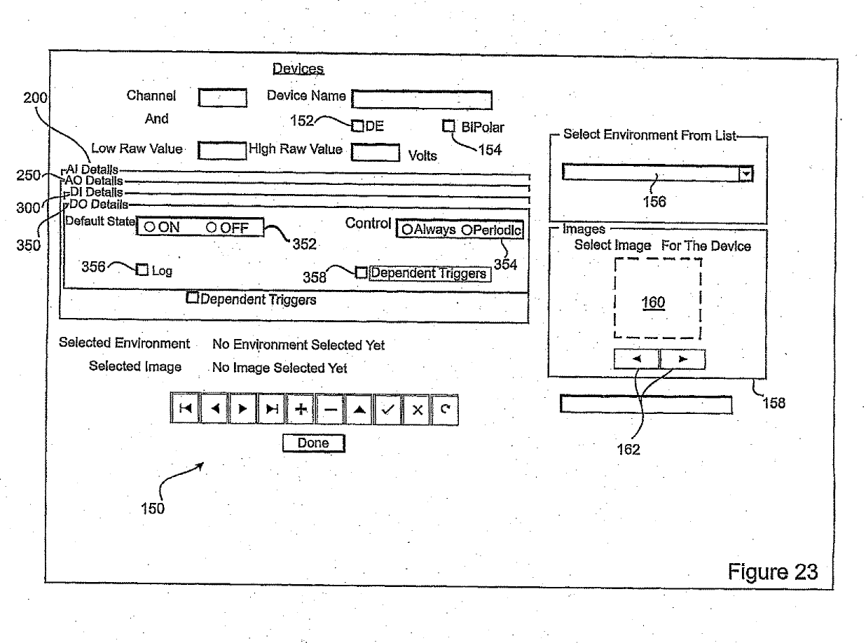

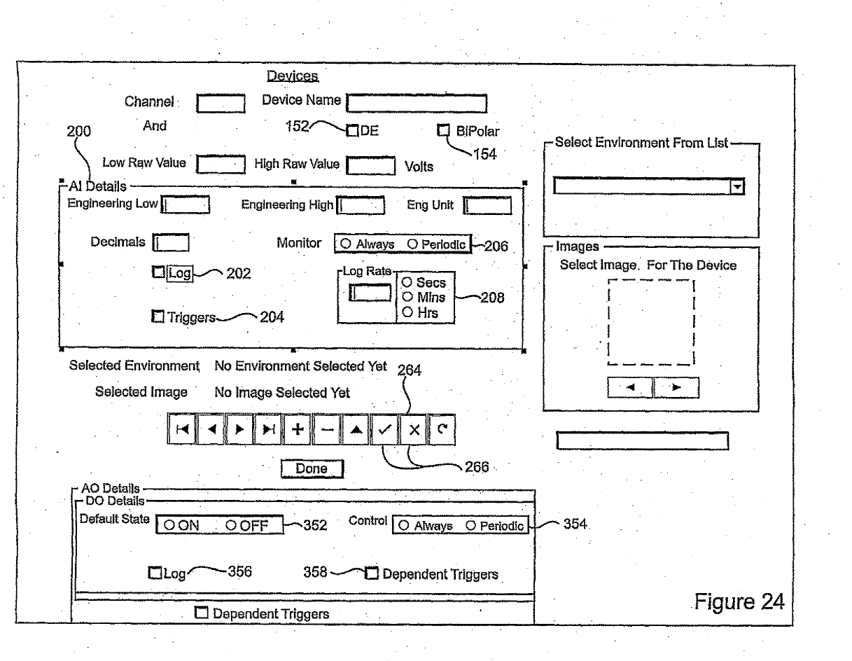

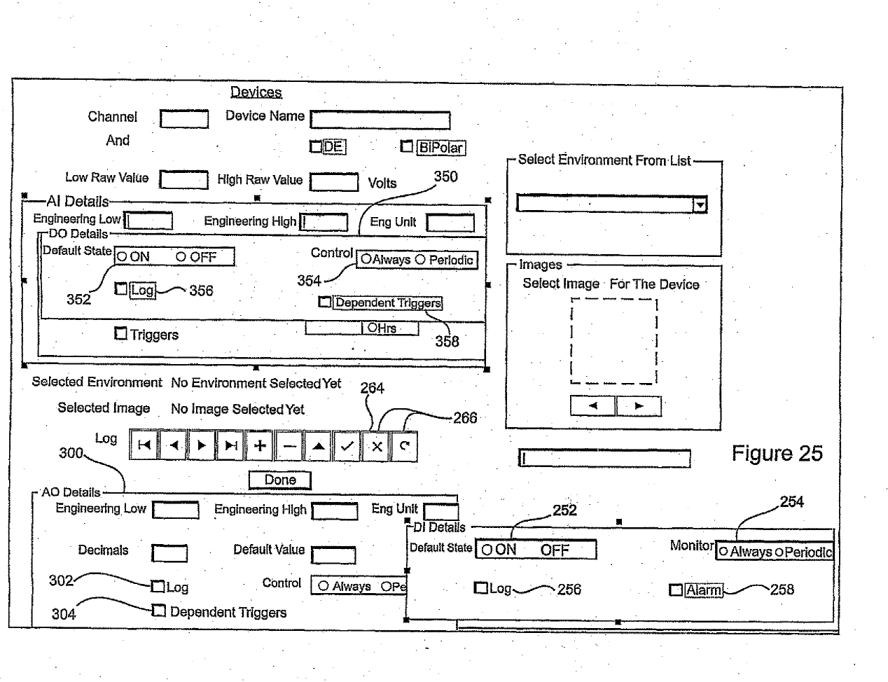

The user is then presented with form window 150, as shown in FIG. 22, or similar, (which replaces form window 100 if displayed). Form window 150 displays information in respect of the first process control peripheral device 14 discovered during the scan of the I/O ports 24. Subsequent representations of window 150 each relate to a further process control peripheral device 14 discovered during the scan of the I/O ports 24.

Form window 150 requires the user to enter the following information:

The name to be used to identify the process control peripheral device 14; and

The channel through which the PAC 12 connects to the process control peripheral device 14. Typically, this is a number.

The Low Raw Value of the process control peripheral device 14. This corresponds with the minimum electrical signal generated by the process control peripheral device 14.

The High Raw Value of the process control peripheral device 14. This corresponds with the maximum electrical signal generated by the process control peripheral device 14.

Typically, the latter two pieces of information can be obtained from the operating specifications of the process control peripheral device 14.

With any analogue inputs, the user is also directed to provide further information in respect of the process control peripheral device 14 by:

Clicking on check box 152 if the process control peripheral device 14 is either ground referenced (Single Ended or SE) or differential (Double Ended or DE);

Clicking on check box 154 if the process control peripheral device 14 is bipolar.

Selecting an environment from drop down list 156. Drop down list 156 includes the names of all environments stored in database 30. If no environments have been defined, drop down list 156 is inaccessible to the user.

Selecting an image with which to represent the process control peripheral device 14 from a slide-show 158. Selectable images are displayed on a rotational basis within window 160 by using directional buttons 162. The default state of window 160 is to display no image.

There are some values that are common to all types of peripheral devices 14, such as identifiers, while some values such as calibration values that are specific. Not all peripheral devices 14 require calibration.

Whether the process control peripheral device 14 is a differentiator or is bipolar can typically be obtained from the operating specifications of the process control peripheral device 14.

Upon display of form window 150, or similar, additional form windows 200, 250, 300, 350, or similar, are arranged in a cascading fashion and in a manner so as not to intrude upon view of the data entry areas of form window 150. These form windows represent, in order, analogue input form window 200, analogue output form window 250, digital input form window 300 and digital output form window 350.

Analogue input form window 200 directs the user to enter in the following information:

The Low Engineering Value of the process control peripheral device 14. This corresponds with the minimum value of the factor to be measured the process control peripheral device 14 is capable of measuring.

The High Engineering Value of the process control peripheral device 14. This corresponds with the maximum value of the factor to be measured the process control peripheral device 14 is capable of measuring.

The Engineering Unit. This is the measurement unit used in measuring the factor to be measured.

The number of decimal places to be taken into consideration in any measurement.

As mentioned above, there are some values that are common to all types of peripheral devices 14 while some values that are specific.

Again, the first two pieces of information can typically be obtained from the operating specifications of the process control peripheral device 14. Furthermore, by comparing the engineering values with the raw values, it is possible to determine the correlation between a value of little meaning to a user (ie. the raw electrical value) and a value of significant meaning to a user (ie. the engineering value). This then allows data communication to the user to be conducted on the basis of the engineering value alone.

The user is also directed to provide additional information in the form of:

Clicking on log checkbox 202 if the input values generated by the process control peripheral device 14 are to be logged in the appropriate table of database 30. If this checkbox 202 is set, the user is also directed towards radio button grouping 208. Radio button grouping 208 lets the user set the time interval to elapse between logging input values generated by the process control peripheral device 14.

Clicking on check box 204 if the input provided by the process control peripheral device 14 will be used as a trigger for action by this process control peripheral device 14.

Selecting whether this process control peripheral device 14 is an always active component of the process control system 10 or a periodic active component.

Digital input window 250, or similar, comprises two radio button sets 252, 254 and two check boxes 256, 258. Radio button set 252 represents the default input state of the process control peripheral device 14—ie. off or on. Radio button set 254 represents whether the process control peripheral device 14 is an always active component of the process control system 10 or a periodic active component. The user is directed to choose the appropriate radio button from each radio button set 252, 254 as suits circumstances.

The user is also directed to click on check box 256 if the input values generated by the process control peripheral device 14 are to be logged in the appropriate table of database 30. Similarly, the user is directed to click on check box 258 if the input values provided by the process control peripheral device 14 are to be monitored for alarm purposes.

Analogue output form 300, or similar, directs the user to enter in the following information:

The Low Engineering Value of the process control peripheral device 14.

The High Engineering Value of the process control peripheral device 14.

The Engineering Unit.

The number of decimal places to be taken into consideration in any measurement.

The default output value.

Each of the first four items described in the preceding list correspond with the information requested in the analogue input form window 200.

The user is also directed to provide additional information in the form of:

Clicking on log checkbox 302 if the output values generated by the process control peripheral device 14 are to be logged in the appropriate table of database 30.

Clicking on check box 304 if the output provided by the process control peripheral device 14 will be used as a catalyst trigger for action by another process control peripheral device 14.

Selecting whether this process control peripheral device 14 is an always active component of the process control system 10 or a periodic active component.

Digital output form window 350 comprises two radio button sets 352, 354 and two check boxes 356, 358. Radio button set 352 represents the default output state of the process control peripheral device 14—ie. off or on. Radio button set 354 represents whether the process control peripheral device 14 is an always active component of the process control system 10 or a periodic active component. The user is directed to choose the appropriate radio button from each radio button set 352, 354 as suits circumstances.

The user is also directed to click on check box 356 if the output values Of the process control peripheral device 14 are to be logged in the appropriate table of database 30. Similarly, the user is directed to click on check box 358 if the output provided by the process control peripheral device 14 will be used as a possible trigger for action by another process control peripheral device 14.

Once the user has sought to define each process control peripheral's operating parameters, the configuration process continues on the user clicking on control button 162. At this stage, the information recorded in respect of each process control peripheral is then written to peripheral configuration file 34

Alternatively, the user may view and/or modify the defined parameters, as well as add yet further parameter information, by means of tool bar 264. The icons 266 represented on toolbar 264 perform the same actions as those represented on toolbar 106, albeit in respect of different data. The last icon 266 on toolbar 264 allows the user to skip entering information in respect of the then current process control peripheral device 14.

With at least some of the process control peripheral devices 14 operating parameters having been defined, the user is then prompted to set the triggers applicable to each process control peripheral device 14 in trigger form window 400.

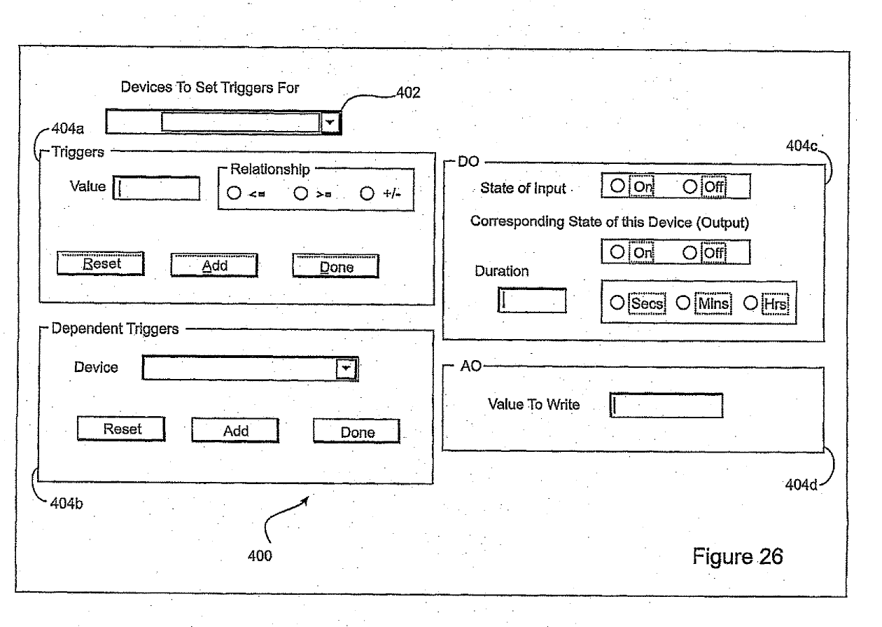

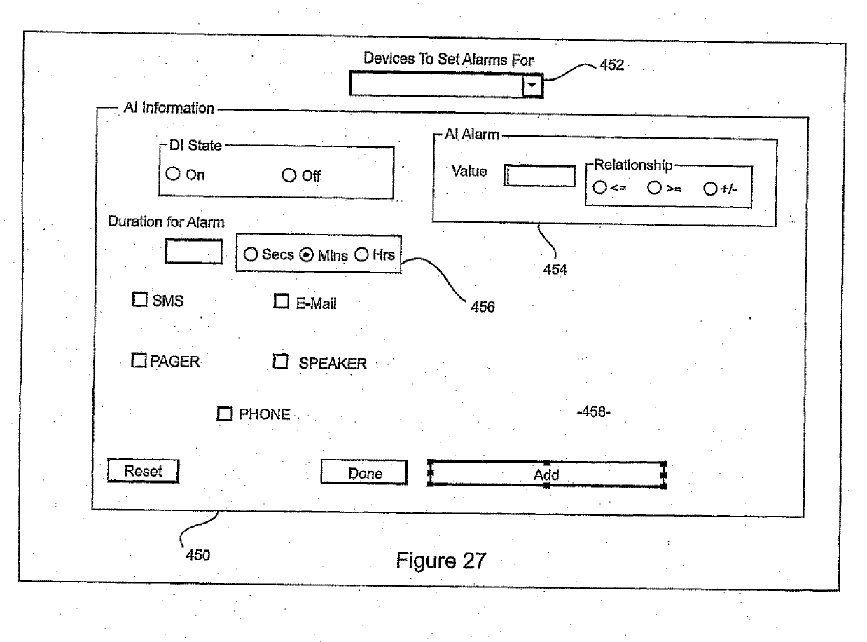

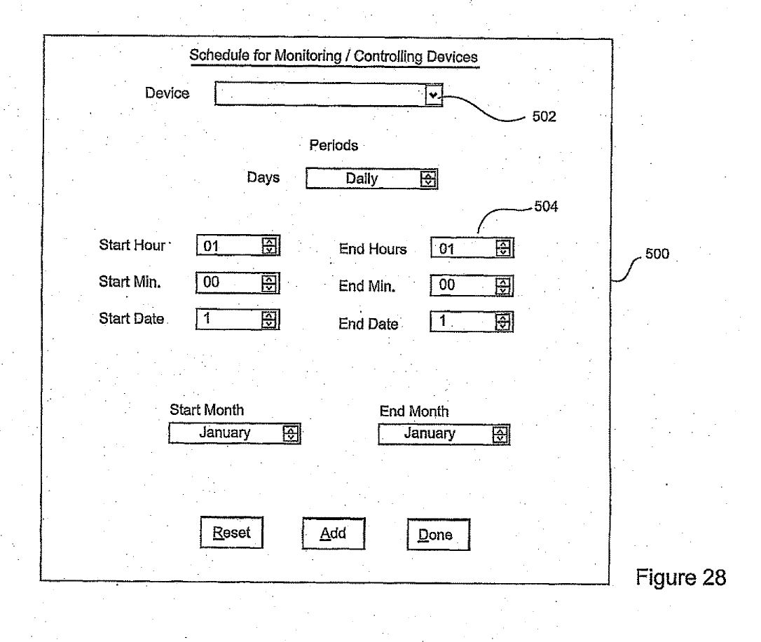

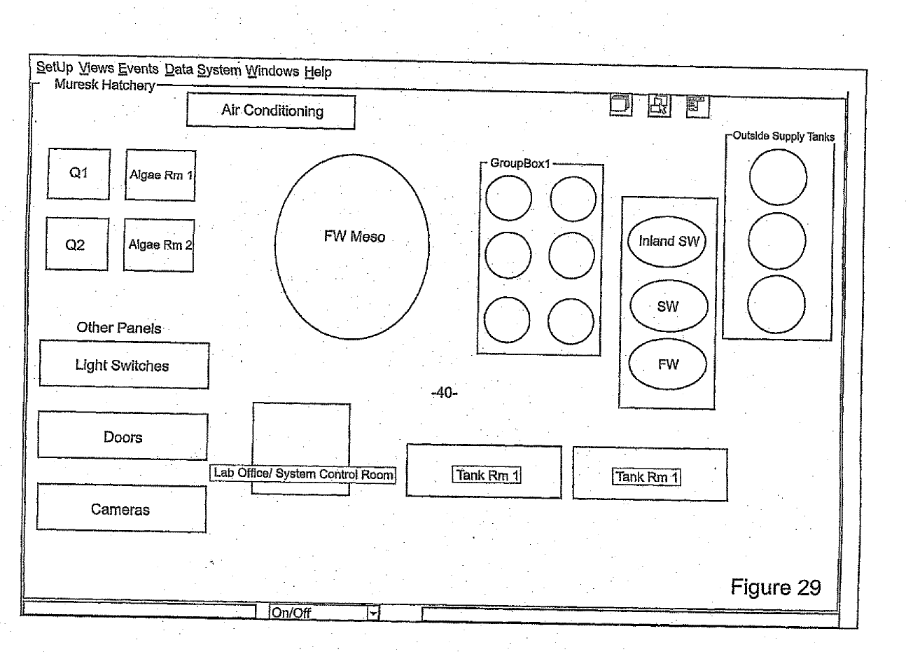

Trigger form window 400 comprises a pull down menu 402 and four data areas 404a, 404b, 404c and 404d (see FIG. 26). Pull down menu 402 contains a list of process control peripherals device 14 for which the user previously indicated will be involved in trigger processing from which the user is to select.

In data area 404a, the user sets the trigger condition as a mathematical equation, in data area 404b, the user chooses the process control peripheral device 14 upon which the trigger condition will operate. In data area 404c, the user sets the input/output correlation between the device selected via pull down menu 402 and the device selected via data area 404b upon activation of a trigger condition. The user also sets the time duration to watt before rechecking that the trigger condition exists—thereby preventing a trigger from activating on a single anomalous value. In data area 404d the user sets the analogue output value to be provided upon activation of a trigger condition. Confirmation of each trigger condition is attained by means of control buttons 410.

Alert form window 450 includes a pull down menu 452. Pull down menu 452 contains a list of process control peripheral devices 14 for which the user previously indicated will be involved in alarm processing from which the user is to select.

Alarms can be activated on the basis of a digital input value or an analogue input value. In the case of an analogue input value the conditions for the alarm can be specified by the user using the field and radio button combination of data input area 454. The user is also directed to set the time duration for the alarm at data input area 456. Finally, the user is directed to provide an indication as to the method of communicating the alarm by clicking on one or more of checkboxes 458.

Finally, the user is directed towards scheduling form window 500. Scheduling form window 500 comprises a pull-down list 502. Pull down list 502 contains a list of all process control peripheral devices 14 previously identified as being periodically active. The user may then select any such process control peripheral device 14 and, using the fields set out in data entry area 504, schedule the times of operation of that process control peripheral device 14.

As each form window operates independently of each other form window, it is possible for the user to exit the configuration process at any stage. When this occurs, and on completion of the configuration process, the user is displayed a human/machine interface (“HMI”) 40 via display means 26. HMI 40 displays to the user all environments specified by the user in respect of the process to be controlled. Each environment is depicted in the HMI 40 by its selected shape with its name displayed in close proximity. Where a process control peripheral device 14 has been specified by the user as related to an environment, the process control peripheral is also displayed in the HMI 40 by its selected image and name the image and name being contained within the shape of the related environment.

The user is then free to view information in respect of any environment or process control peripheral as they see fit by double-clicking on the shape or image, as appropriate. The user may also re-configure the process control system 10, or any part thereof, by accessing the appropriate form window and changing the values recorded therein. Where appropriate, these changes are then committed to the peripheral configuration file 34, Re-configuration may also occur on addition of further process control peripheral devices 14. In such a case, software 32 operates to conduct a further scan of all I/O ports 24 to discover the new process control peripheral devices 14. Processing in respect of the new process control peripheral devices 14 occurs in the same manner as if such process control peripheral devices 14 were discovered as part of the initial configuration process.

Due to the interrelationships defined by the various form windows, software 32 is able to facilitate simulations aimed attesting the operation of the defined process control system 10. This allows users to verify the process control system 10 operates as intended before being put into commercial operation. Furthermore, software 32 can assess the various process control peripheral device 14 information to determine such errors as:

Whether all process control peripherals specified as being associated with trigger conditions are actually associated with a trigger condition.

Whether all process control peripherals specified as being periodically active are scheduled to operate at least once; and

Whether all process control peripheral devices 14 specified as being subject to alarm processing have set alarm criteria.

The system may then operate in accordance with the parameters set by the user and as would be apparent to the person skilled in the art.

A second user may access current data and data stored in database 30 of the PAC 12 via computer 16. In this manner, the second user can monitor the process control peripheral devices 14 and the operation of the PAC 12 from a remote location. Furthermore, the second user can conduct a series of queries on the communicated data directed towards such issues as:

detecting and analysing past and present data trends;

providing supporting data for qualify assurance and/or regulatory requirement purposes;

analysing past performance as a means of improving the monitored process;

repeating past successes; and

make comments that are associated with the timestamped data.

The information resulting from these queries may be embodied in reports and a report generation tool is included for such purposes.

Once the configuration process 38 has been completed then the process control system 10 is ready to control the requested process.

For example, a process control system 10 may be needed to warn if oxygen levels fell too low in an aquaculture tank and to take a picture of the scene for records and provide a warning to the user via SMS. In this embodiment, the process control system 10 would comprise process control peripheral devices 14 of at least one camera and data acquisition devices, such as oxygen sensors with at least one valve, would be coupled to the PAC 12.

The configuration process 38 would enable channels to be configured for each oxygen sensor and valves and then trigger levels configured to be calculated by a mathematical equation. The cameras would be configured for resolution and frequency. End user contact information to be provided by SMS would be entered.

Using the HMI 40, a dependency would then be set up between the oxygen sensor and the valve to open the oxygen valve if the mathematical equation is satisfied. Similarly this could also be done for the camera so that a picture is taken under the same conditions.

If the PAC 12, under operation of the run time processes 42, determines that the mathematical equation indicates that the oxygen level is too low, images from the cameras would be grabbed using the Image Grabber Process 72 (or other processes if it were video camera information) and the grabbed images or pictures would be stored into the database 30, or another similar location. The PAC 12 would then be operable to generate an SMS and under control of the communications process 64, an SMS message would be sent out to the end user, in addition, under control of the PAC 12 and the run-time processes 42, a signal would be sent to the valve from the Main Process 82 using the Writer Process 94, and upon receiving the signal the valve would be actuated to release oxygen and prevent fish from dying. As an alternative, a similar control sequence could be configured in the PAC 12 by the end user.

Further the features of this system facilitates the easy setup and configuration of the automation system. The process control system 10 can use the aforementioned processes, and in particular the Scanner Process 84 process control to scan the current state of the process control peripheral devices 14 when the user has ensured that tie system devices are largely physically set to default or correct states. This is most advantageous during a test period or when the process control system 10 is being commissioned, but may also be used during operations—any time that an overall view of system states is beneficial. The value read by the scanner is compared to the information provided by the user when configuring the process control peripheral device 14 and variances can be displayed back to the user by the graphical interface that either indicates that each process control peripheral device 14 is in a default or normal state, or trigger condition or alarm state, or was indeterminate because of inconsistent data, possibly due to connection errors. The status of each process control peripheral device 14 can be shown using appropriate textual or graphical status including colour change.

The combination of features allowing configuration, scanning and graphical display greatly simplifies and shortens the time required to configure, commission and troubleshoot a system.

The process control peripheral devices 14 connected to the PAC 12 may comprise an input or output device which may operate in two or more states or over a specified range. The Scanning Process 84 reads the configuration settings for each process control peripheral device 14 connected to the PAC 12 and writes the actual values read for the Main Process 82 to action. The Main Process 82 processes the scanned data by comparing with user configured values and instructs the Writer Process 94 to control the process control peripheral devices 14 connected to the PAC 12 as required and update the display means.

This process is integrated into one easy to use product and interface and yet is extremely flexible in order to be applicable to this particular situation or any general situation.

As can be appreciated by the person skilled in the art, the invention is neither limited to a particular application environment nor limited to the embodiments described. For example:

The invention may be used in the reticulation/irrigation sector as a means of controlling solenoids, valves, tensiometers and pumps.

The invention may be used in the security sector as a means of controlling alarms, speakers and sirens as well as being able to stream and capture image data from close circuit cameras within the secured area. Alternatively, or conjunctively, the invention may be used to inform employees within a secured area of the presence of a visitor who has come to see them or an intruder.

The invention may be used to detect gas or other hazards and implement a response procedure to such hazard;

The invention may be incorporated as part of a weather station to detect temperature, wind, rain arid dew levels.

The invention may be used to control an air conditioning system based on readings-taken from an associated thermometer and heat exchanger,

The invention may be used to control lighting requirements based on such factors as time, detected movement and background illumination level.

The invention may be used in the water quality sector to monitor and control factors such as dissolved oxygen, temperature, pH, ORP, salinity, turbidity, water level and flow rate.

It should also be appreciated by the person skilled in the art that the invention is not limited to the embodiments described, in particular, the system may be modified to increase the level of automation with the user configuring the process control system by means of verifying, and modifying where appropriate, the automated definitions produced by software 32. Additionally, features described in each embodiment may, where not alternatives, be combined to form yet further embodiments.

1-69. (canceled)

70. A process control system comprising a programmable automation controller and at least first and second process control peripheral devices coupled thereto, each process control peripheral device being in data and control communication with the programmable automation controller, wherein the programmable automation controller is operable to: monitor a current situation of an environment in which the at least one of the first or second process control peripheral devices is located; log a previous situation; and control at least one of the first or second process control peripheral devices depending upon the current and previous situations, the programmable automation controller being further operable to: configure the first and second process control peripheral devices; to perform data acquisition on at least one of the first and second process control peripheral devices; and to provide controlling operations by writing data to at least one of the first and second process control peripheral devices coupled to the programmable automation controller in response to the data acquisition and in accordance with the configuration of the first and second process control peripheral devices, the programmable automation controller comprising an operating system comprising a kernel, an interface process for implementation of a configuration process and a core engine for implementation of a run-time process, each of the configuration and run-time processes comprising a plurality of sub-processes having a specific functionality associated therewith, the configuration process being operable to configure the first and second process control peripheral devices through end user inputs to the programmable automation controller, these end user inputs being stored in memory of the programmable automation controller for use by the run-time process.

71. A process control system according to claim 70, wherein one of the sub-processes is a Central Process operable to read data from other sub-processes and from the first and second process control peripheral devices, and to output data to those processes needed for control of at least one of the process control peripherals.

72. A process control system according to claim 70, wherein one of the sub-processes is a Backup Process for providing back up of data.

73. A process control system according to claim 70, wherein one of the sub-processes is a Benchmarking Process for benchmarking data against other similar criteria.

74. A process control system according to claim 70, wherein one of the sub-processes is a Communications Process for controlling the communication of data to an end user of the process control system.

75. A process control system according to claim 70, wherein one of the sub-processes is a Data Pusher for pushing data and/or text that needs to be updated to a visual display means coupled to the programmable automation controller.

76. A process control system according to claim 70, wherein one of the sub-processes is a Designing Process for designing an interface between an end user and the process control system.

77. A process control system according to claim 70, wherein one of the sub-processes is a Video Capture Process for capturing video and/or audio frames or streams from process control peripheral devices comprising video image capturing devices and/or audio capturing devices.

78. A process control system according to claim 77, wherein one of the sub-processes is a Video Process for creating streamed video and/or audio from the Video Capture Process.

79. A process control system according to claim 70, wherein one of the sub-processes is an Image Grabber Process for capturing images from process control peripheral devices comprising still image capturing devices.

80. A process control system according to claim 70, wherein one of the sub-processes is an Image Pusher Process for pushing images from a process control peripheral device to an image receiving device coupled to the programmable automation controller.

81. A process control system according to claim 70, wherein one of the sub-processes is a System Install Process operable to facilitate initial installation, and diagnostic processes stored on the programmable automation controller after installation.

82. A process control system according to claim 70, wherein one of the sub-processes is a Sequence Process operable by an end user to customise the operability of the process control system.

83. A process control system according to claim 70, wherein one of the sub-processes is a Plot Process for controlling the plotting of data stored on the programmable automation controller.

84. A process control system according to claim 70, wherein one of the sub-processes is a Scanner Process for scanning the process control peripheral devices coupled to the programmable automation controller to determine the state of at least one of the process control peripheral devices coupled thereto and to determine a value indicative of that state, whereby the programmable automation controller is operable to compare the scanned value with a predetermined stored value and, where a difference between the scanned and the stored value are determined, the programmable automation controller is operable to display an indication of the difference on a display means coupled to the programmable automation controller.

85. A process control system according to claim 70, wherein one of the sub-processes is a Scheduler Process for scheduling actions and operations of the process control system.

86. A process control system according to claim 70, wherein one of the sub-processes is a System Update Process for updating the process control system.

87. A process control system according to claim 70, wherein one of the sub-processes is a Utilities Process operable to determine the optimal operation and current status of the process control system.

88. A process control system according to claim 70, wherein one of the sub-processes is a Writer Process operable to write output data to process control peripheral devices, and memory.

89. A process control system according to claim 70, wherein the first and second process control peripheral devices are separate devices.

90. A process control system according to claim 70, wherein the first and second process control peripheral devices are the same device.

91. A programmable automation controller for use with the process control system according to claim 70, wherein the programmable automation controller is operable to: monitor a current situation of the environment in which the at least one of the first or second process control peripheral devices is located; log a previous situation; and control at least one of the first or second process control peripheral devices depending upon the current and previous situations, the programmable automation controller being further operable to configure the first and second process control peripheral devices; to perform data acquisition on at least one of the first and second process control peripheral devices; and provide controlling operations by writing data to at least one of the first and second process control peripheral devices coupled to the programmable automation controller in response to the data acquisition and in accordance with the configuration of the first and second process control peripheral devices, and wherein the programmable automation controller includes an operating system comprising a kernel, an interface process for implementation of a configuration process and a core engine for implementation of a run-time process, each of the configuration and run-time processes comprising a plurality of sub-processes having a specific functionality associated therewith, the configuration process being operable to configure the first and second process control peripheral devices through end user inputs to the programmable automation controller, these end user inputs being stored in memory of the programmable automation controller for use by the run-time process.

92. A programmable automation controller according to claim 91, wherein one of the sub-processes is a Central Process operable to read data from other sub-processes and from the first and second process control peripheral devices and to output data to those processes needed for control of at least one of the process control peripheral devices.

93. A programmable automation controller according to claim 91, wherein one of the sub-processes is a Backup Process for providing back up of data.

94. A programmable automation controller according to claim 91, wherein one of the sub-processes is a Benchmarking Process for benchmarking data against other similar criteria.

95. A programmable automation controller according to claim 91, wherein one of the sub-processes is a Communications Process for controlling the communication of data to an end user of the process control system.

96. A programmable automation controller according to claim 91, wherein one of the sub-processes is a Data Pusher for pushing data and/or text that needs to be updated to a visual display means coupled to the programmable automation controller.

97. A programmable automation controller according to claim 91, wherein one of the sub-processes is a Designing Process for designing an interface between an end user and the process control system.

98. A programmable automation controller according to claim 91, wherein one of the sub-processes is a Video Capture Process for capturing video and/or audio frames or streams from process control peripheral devices comprising video image capturing devices and/or audio capturing devices.

99. A programmable automation controller according to claim 98, wherein one of the sub-processes is a Video Process for creating streamed video and/or audio from the Video Capture Process.

100. A programmable automation controller according to claim 91, wherein one of the sub-processes is an Image Grabber Process for capturing images from process control peripheral devices comprising still image capturing devices.

101. A programmable automation controller according to claim 91, wherein one of the sub-processes is an Image Pusher Process for pushing images from a process control peripheral device to an image receiving device coupled to the programmable automation controller.

102. A programmable automation controller according to claim 91, wherein one of the sub-processes is a System Install Process operable to facilitate initial installation, and diagnostic processes stored on the programmable automation controller after installation.

103. A programmable automation controller according to claim 91, wherein one of the sub-processes is a Sequence Process operable by an end user to customise the operability of the process control system.

104. A programmable automation controller according to claim 91, wherein one of the sub-processes is a Plot Process for controlling the plotting of data stored on the programmable automation controller.

105. A programmable automation controller according to claim 91, wherein one of the sub-processes is a Scanner Process for scanning the process control peripheral devices coupled to the programmable automation controller to determine the state of at least one of the process control peripheral devices coupled thereto and to determine a value indicative of that state, whereby the programmable automation controller is operable to compare the scanned value with a predetermined stored value and, where a difference between the scanned value and the stored value are determined, the programmable automation controller is operable to display an indication of the difference on a display means coupled to the programmable automation controller.

106. A programmable automation controller according to claim 91, wherein one of the sub-processes is a Scheduler Process for scheduling actions and operations of the process control system.

107. A programmable automation controller according to claim 91, wherein one of the sub-processes is a System Update Process for updating the process control system.

108. A programmable automation controller according to claim 91, wherein one of the sub-processes is a Utilities Process operable to determine the optimal operation and current status of the process control system.

109. A programmable automation controller according to claim 91, wherein one of the sub-processes is a Writer Process operable to write output data to process control peripheral devices, and memory.

110. A programmable automation controller according to claim 91, wherein the first and second process control peripheral devices are separate devices.

111. A programmable automation controller according to claim 91, wherein the first and second process control peripheral devices are the same device.

112. A method for operating a process control system, the process control system comprising a programmable automation controller and first and second process control peripheral devices coupled thereto, each process control peripheral device being in data and control communication with the programmable automation controller, the method comprising the, steps of: monitoring a current situation of an environment in which at least one of the first or second process control peripheral devices is located; logging a previous situation; and controlling at least one of the first or second process control peripheral devices depending upon the current and previous situations, the method comprising the further steps of: configuring the first and second process control peripheral devices; performing data acquisition on at least one of the first and second process control peripheral devices; and providing controlling operations by writing data to at least one of the first and second process control peripheral devices coupled to the programmable automation controller in response to the data acquisition and in accordance with the configuration of the first and second process control peripheral devices, and wherein the configuration, data acquisition and controlling are provided by a configuration process and a run-time process, the configuration process being implemented through an interface process and the run-time process being implemented through a core engine, each of the configuration and run-time processes comprising a plurality of sub-processes having a specific functionality associated therewith, the configuration process being operable to configure the first and second process control peripheral devices through end user inputs to the programmable automation controller, these end user inputs being stored in memory of the programmable automation controller for use by the run-time process.

113. A method according to claim 112, wherein one of the sub-processes is a Central Process operable to read data from other sub-processes and from the first and second process control peripheral devices, and to output data to those processes needed for control of at least one of the process control peripheral devices.

114. A method according to claim 112, wherein one of the sub-processes is a Backup Process for providing back up of data.

115. A method according to 112, wherein one of the sub-processes is a Benchmarking Process for benchmarking data against other similar criteria.

116. A method according to claim 112, wherein one of the sub-processes is a Communications Process for controlling the communication of data to an end user of the process control system.

117. A method according to claim 112, wherein one of the sub-processes is a Data Pusher for pushing data and/or text that needs to be updated to a visual display means coupled to the programmable automation controller.

118. A method according to claim 112, wherein one of the sub-processes is a Designing Process for designing an interface between an end user and the process control system.

119. A method according to claim 112, wherein one of the sub-processes is a Video Capture Process for capturing video and/or audio frames or streams from process control peripheral devices comprising video image capturing devices and/or audio capturing devices.

120. A method according to claim 112, wherein one of the sub-processes is a Video Process for creating streamed video and/or audio from the Video Capture Process.

121. A method according to claim 112, wherein one of the sub-processes is an Image Grabber Process for capturing images from process control peripheral devices comprising still image capturing devices.

122. A method according to claim 112, wherein one of the sub-processes is an Image Pusher Process for pushing images from a process control peripheral device to an image receiving device coupled to the programmable automation controller.

123. A method according to claim 112, wherein one of the sub-processes is a System Install Process operable to facilitate initial installation, and diagnostic processes stored on the programmable automation controller after installation.

124. A method according to claim 112, wherein one of the sub-processes is a Sequence Process operable by an end user to customise the operability of the process control system.

125. A method according to claim 112, wherein one of the sub-processes is a Plot Process for controlling the plotting of data stored on the programmable automation controller.

126. A method according to claim 112, wherein one of the sub-processes is a Scanner Process for scanning the process control peripheral devices coupled to the programmable automation controller to determine the state of at least one of the process control peripheral devices coupled thereto and to determine a value indicative of that state, whereby the scanned value is compared with a predetermined stored value and, where a difference between the scanned value and the stored value are determined, the method including the further step of displaying an indication of the difference on a display means coupled to the programmable automation controller.

127. A method according to claim 112, wherein one of the sub-processes is a Scheduler Process for scheduling actions and operations of the process control system.

128. A method according to claim 112, wherein one of the sub-processes is a System Update Process for updating the process control system.

129. A method according to claim 112, wherein one of the sub-processes is a Utilities Process operable to determine the optimal operation and current status of the process control system.

130. A method according to claim 112, wherein one of the sub-processes is a Writer Process operable to write output data to process control peripheral devices, and memory.

131. A method according to claim 112, wherein the first and second process control peripheral devices are separate devices.

132. A method according to claim 112, wherein the first and second process control peripheral devices are the same device.

133. A process control system comprising a programmable automation controller and at least one process control peripheral device coupled thereto, the at least one process control peripheral device being in data and control communication with the programmable automation controller, wherein the programmable automation controller is operable to: monitor the current situation of an environment in which the at least one process control peripheral device is located; log a previous situation; and control the at least one process control peripheral device depending upon the current and previous situations, the programmable automation controller being further operable to: configure the at least one process control peripheral device; to perform data acquisition on the at least one process control peripheral device; and to provide controlling operations by writing data to the at least one process control peripheral device coupled to the programmable automation controller.

134. A programmable automation controller for a process control system having at least one process control peripheral device coupled thereto, the at least one process control peripheral device being in data and control communication with the programmable automation controller, wherein the programmable automation controller is operable to: monitor the current situation of an environment in which the at least one process control peripheral device is located; log a previous situation; and control the at least one process control peripheral device depending upon the current and previous situations, the programmable automation controller being further operable to: configure the at least one process control peripheral device; to perform data acquisition on the at least one process control peripheral device; and to provide controlling operations by writing data to the at least one process control peripheral device coupled to the programmable automation controller.

135. A method for operating a process control system, the process control system comprising a programmable automation controller and at least one process control peripheral device coupled thereto, the at least one process control peripheral device being in data and control communication with the programmable automation controller, wherein the method comprises the steps of: monitoring the current situation of an environment in which the at least one process control peripheral device is located; logging a previous situation; and controlling the at least one process control peripheral device depending upon the current and previous situations, the method including comprising the further steps of; configuring the at least one process control peripheral device; performing data acquisition on the at least one process control peripheral device; and providing controlling operations by writing data to the at least one process control peripheral device coupled to the programmable automation controller.
